(19) United States
(12) Patent Application Publication
(10) Pub. No.: US 2022/0209965 A1
(43) Pub. Date: Jun. 30, 2022

(54) REPUDIABLE CREDENTIALS

(71) Applicant: FUJITSU LIMITED, Kawasaki-shi (JP)

(72) Inventors: Hart MONTGOMERY, Redwood City, CA (US); Arnab ROY, Santa Clara, CA (US)

(73) Assignee: FUJITSU LIMITED, Kawasaki-shi (JP)

(21) Appl. No.: 17/138,697

(22) Filed: Dec. 30, 2020

(51) Int. Cl. H04L 9/32; H04L 9/08

(52) U.S. Cl. CPC H04L 9/3271; H04L 9/0825; H04L 2209/38; H04L 9/0838; H04L 9/083

(57) ABSTRACT

A method may include obtaining policy information and a public key from a first trusted authority regarding an attribute of users to be verified, and generating a challenge query based on the public key, the policy information, and a verifier random value. The method may also include sending the challenge query to a user to verify the attribute of the user. The method may additionally include receiving a response from the user that is responsive to the challenge query, where the response is based on the challenge query and a user-specific secret key obtained by the user from a second trusted authority, and the user-specific secret key is generated by the trusted authority based on a general secret key corresponding to the public key and the attribute of the user. The method may also include verifying the attribute of the user based on the response.

### FIELD

Embodiments of the present disclosure relate to repudiable credentials, and in particular, the use of repudiable credentials in verifying an attribute of a user.

### BACKGROUND

Verifying credentials can be a difficult process. For example, someone seeking to verify their age, or their identity, may be required to provide various components of information to verify their credentials. However, in many circumstances, such credential verification has been unchanged for many years.

### SUMMARY

One or more embodiments of the present disclosure may include a method that includes obtaining policy information and an electronic public key (hereinafter, “public key”) from a first trusted authority regarding an attribute of users to be verified, and generating a challenge query based on the public key, the policy information, and a verifier random value. The method may also include sending the challenge query to a user to verify the attribute of the user. The method may additionally include receiving a response from the user that is responsive to the challenge query, where the response is based on the challenge query and a user-specific secret key obtained by the user from a second trusted authority, and the user-specific secret key is generated by the second trusted authority based on a general secret key corresponding to the public key and the attribute of the user. The method may also include verifying the attribute of the user based on the response.

The object and advantages of the embodiments will be realized and achieved at least by the elements, features, and combinations particularly pointed out in the claims.

It is to be understood that both the foregoing general description and the following detailed description are merely examples and explanatory and are not restrictive.

### BRIEF DESCRIPTION OF THE DRAWINGS

Example embodiments will be described and explained with additional specificity and detail through the use of the accompanying drawings in which:

FIG. 1 is a diagram illustrating an example system which may utilize repudiable credentials;

FIG. 2 is a diagram illustrating an example environment within which repudiable credentials may be utilized;

FIG. 3 illustrates an example flowchart of an example method of performing preliminary operations to support the use of repudiable credentials;

FIG. 4 illustrates an example flowchart of an example method of the use of repudiable credentials;

FIG. 5 illustrates an example computing system.

### DETAILED DESCRIPTION

The present disclosure relates to the use of Ciphertext-Policy Attribute-Based Encryption (CP-ABE) to facilitate the use of repudiable credentials. For example, a user may have a credential such as a driver's license or a bank account that can be used to verify one or more attributes associated with the credential. However, the user may not want to provide all of the information available via the credential (e.g., the user may not want to divulge their home address, driver's license number, etc. when verifying their age). The use of the CP-ABE encryption scheme as described herein may facilitate the use of a repudiable credential such that the party verifying the attribute of the user only has a verification of the attribute.

In these and other embodiments, a first trusted authorities may generate a general public key and an associated general secret key. The general secret key may be provided to a second trusted authority that manages or controls a given credential (such as a Division of Motor Vehicles (DMV) that manages drivers' licenses), which may or may not be the same as the first trusted authority. The second trusted authority may generate policy information regarding the credential and/or attributes associated with the credential, and the policy information and the general public key may be posted to the blockchain. The second trusted authority may generate a user-specific secret key for each of the users based on an attribute to be verified, and may securely provide a user who desired to have their attribute verified to the respective user. A verifier seeking to verify the attribute of the user may generate a query based on the public key, the policy information, and a verifier random value that the verifier has generated using a CP-ABE encryption algorithm. The query may be provided to the user, who performs a CP-ABE decryption process on the query using the user-specific secret key. The result of the CP-ABE decryption process may be provided to the verifier as a response via which the verifier may validate the attribute of the user.

Certain embodiments of the present disclosure may provide improvements over previous iterations of secure communications and identity validation/verification. For example, embodiments of the present disclosure may provide a more secure interaction between parties by permitting limited exposure of information. In particular, a verifier may be able to verify an attribute of a user in a reliable manner while the user does not have to disclose additional information about the user to validate the attribute. Additionally, embodiments of the present disclosure permits using blockchain technology to facilitate the security and reliability of the public information that facilitates the use of repudiable credentials.

One or more example embodiments are explained with reference to the accompanying drawings.

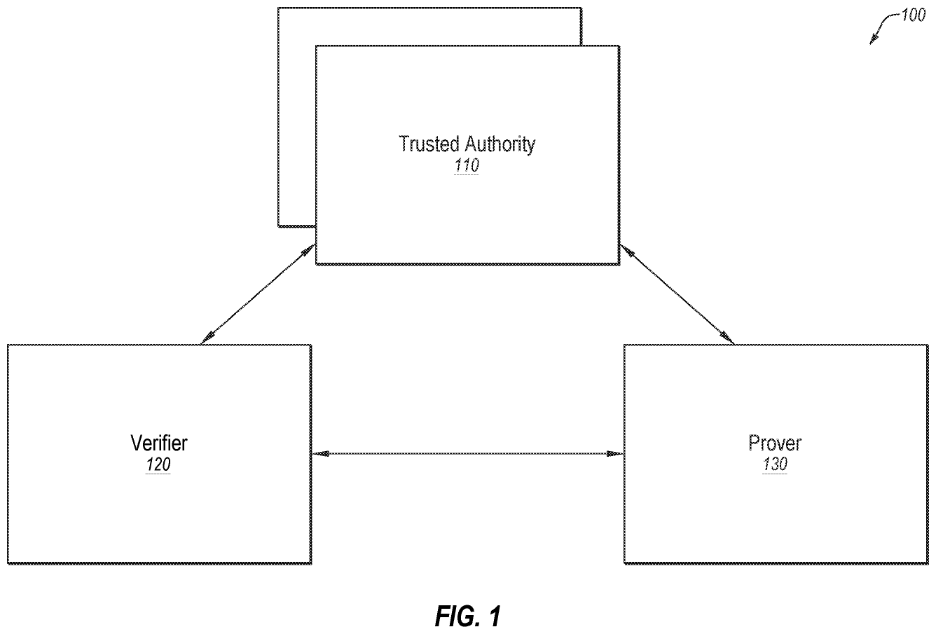

FIG. 1 is a diagram illustrating an example system 100 which may utilize repudiable credentials, in accordance with one or more embodiments of the present disclosure. The system 100 may include one or more trusted authorities 110, a verifier 120 that may seek to verify an attribute or credential of a user, and a prover 130 that may be the user whose attribute or credential is being verified. The system 100 may operate such that in verifying the attribute or credential, the verifier 120 may only verify the credential without obtaining other information regarding the prover 130.

In some circumstances, the verifier 120 may desire to verify a certain credential of a third party. For example, if the verifier 120 operates a bar or pub, the proprietor of the bar may desire to verify that a potential patron is of a legal drinking age, such as twenty one years of age. Typically, such verification involves physically inspecting a driver's license or other identification that may also include other personal information, such as a home address, driver's license number, etc. By using embodiments, of the present disclosure, the verifier 120 may verify the credential of the prover 130 (e.g., the age of the patron) without obtaining other information regarding the prover 130. Stated another way, the present disclosure may facilitate the use of repudiable credentials that prevents the obtaining and/or sharing of personal information with third parties.

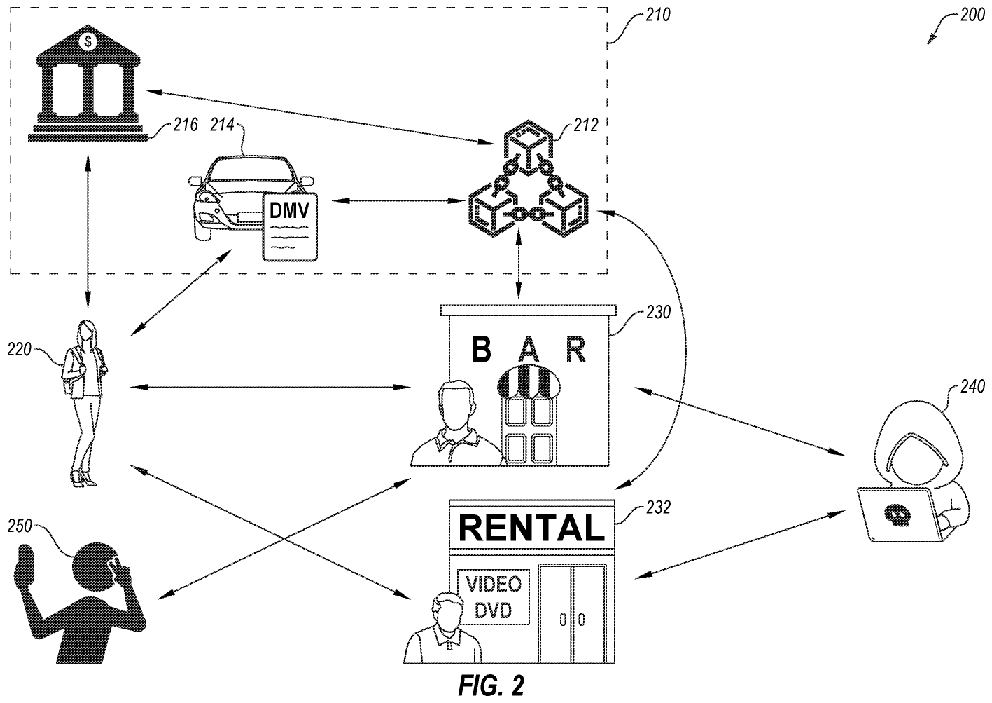

The prover 130 may be any entity seeking to have their credential verified. For example, the patron of the bar or pub may desire to have access to the bar, without the bar being able to collect and/or sell their personal information to some other entity. By using repudiable credentials, the prover 130 is able to have their credential verified while still maintaining their privacy, and the verifier 120 is able to verify the credential of the prover 130. An example of the exchange between the verifier 120 and the prover 130 may be described with greater in reference to FIGS. 2 and/or 4.

In some embodiments, the trusted authority 110 may facilitate the exchange of information between the verifier 120 and the prover 130. For example, the trusted authority 110 may facilitate the generation of one or more keys to facilitate secure communications, the generation of attributes associated with the credentials of the prover 130, and/or the publication of policies regarding the credential and/or attributes to be verified. An example of the operations performed by the trusted authority 110 may be described with greater in reference to FIGS. 2 and/or 3.

In some embodiments, the trusted authority 110 may include multiple entities that may or may not be in communication and/or control of each other and may operate as a distributed trusted authority. For example, the trusted authority 110 may include multiple full nodes, master nodes, or other nodes of a blockchain network authorized to verify and/or write blocks to the blockchain. As another example, the trusted authority 110 may include an entity that controls the credential and/or associated attribute to be verified. For example, the Department of Motor Vehicles (DMV) for a given state or region may control the distribution and/or generation of drivers' licenses and may establish and/or publish policies related to information verifiable by a driver's license. As another example, a bank may control information related to bank account numbers and balances, and may establish and/or publish policies related to information verifiable by bank information. In these and other embodiments, one trusted authority 110 (such as the DMV) may generate policies that are provided to another trusted authority 110 (such as the master nodes/full nodes administering the blockchain) for publication (such as posting to a blockchain).

Modifications, additions, or omissions may be made to the system 100 without departing from the scope of the disclosure. For example, the designations of different elements in the manner described is meant to help explain concepts described herein and is not limiting. Further, the system 100 may include any number of other elements or may be implemented within other systems or contexts than those described.

FIG. 2 is a diagram illustrating an example system 200 within which repudiable credentials may be utilized, in accordance with one or more embodiments of the present disclosure. The system 200 may include trusted authorities 210 (which may include a blockchain 212, a DMV 214, and a bank 216). The system may also include a user 220 who interacts with various verifiers to verify certain credentials, such as interacting with a bar 230 to verify the age of the user 220 and a rental store 232 to verify bank information. A third party 240 may attempt to collect personal information regarding the user 220 from the bar 230 and/or the rental store 232. A teen 250 may attempt to provide fake credentials to the bar 230.

In operation, the DMV 214 may establish policies regarding the credentials over which it has control. For example, the DMV 214 may establish the form, format, etc. of a driver's license, the information contained therein, the availability of individual pieces of information for owners of the credentials, etc. The DMV 214 may send these policies to be posted to the blockchain 212. Similarly, the bank 216 may establish policies regarding the credentials over which it has control. For example, the bank 216 may establish the form, format, etc. of bank account information, the availability of account numbers, account balances, routing numbers, etc. The bank 216 may send these policies to be posted on the blockchain 212.

In some embodiments, one or more of the trusted authorities 210 may facilitate generation of public and private keys to facilitate the use of repudiable credentials. For example, the trusted authority 210 may generate a general secret key and a general public key using a security parameter, according to a Ciphertext-Policy Attribute-Based Encryption (CP-ABE) master secret key generation algorithm. Stated mathematically, the trusted authority 210 may perform
KeyGen (mpk, msk)=CPABE.mskgen(λ)
   where λ represents the security parameter (indicating a level of security), mpk represents a general public key, msk represents a general secret key, and CPABE.mskgen represents a key generation function according to a CP-ABE algorithm. In some embodiments, such a master authority may include the master nodes and/or full nodes managing the blockchain 212 and the general public key may be posted to the blockchain 212. Additionally or alternatively, each of the entities responsible for a policy and/or credential may generate their own respective public key and general secret key.

In some embodiments, each the trusted authorities 210 responsible for a given credential of a user may generate the specific attributes of the users corresponding to the credentials. For example, the DMV 214 may generate drivers' license numbers for users, in addition to other information related to the users (e.g., birth dates, home addresses, etc.). In these and other embodiments, a user-specific secret key may be generated for one or more of the attributes associated with the credential using a CP-ABE key generation algorithm. Stated mathematically, the trusted authority 210 (such as the DMV 214 and/or the bank 216) may perform
sk=CPABE.keygen(msk, attributes)
   where attributes represents the attributes associated with the credentials of the respective users, sk represents a user-specific secret key associated with the specific attribute, msk represents the general secret key, and CPABE.keygen represents a key generation function according to a CP-ABE algorithm. In some embodiments, after generation of the user-specific secret key sk, the trusted authority may securely provide sk to the respective users. For example, with reference to FIG. 2, the user 220 may establish a secure communication session with the DMV 214 and receive sk as a user-specific secret key used to validate the attribute of their age. As another example, the user 220 may login to a secure portal with the bank 216 and download sk as a user-specific secret key used to validate their bank account and/or balance.

In some embodiments, when an entity such as the bar 230 seeks to verify an attribute of the user 220, the bar 230 may obtain the general public key (e.g., mpk) and the policies related to the attribute for which the bar 230 seeks to validate. For example, the bar 230 may access the blockchain 212 to retrieve the general public key mpk and the policies as established by the DMV 214 related to verifying a date of birth. Using the general public key mpk, the policy/policies, and a random value generated by the bar 230, the bar 230 may generate a query to be sent to the user 220 to verify their attribute. Stated mathematically, the bar 230 may perform
chal=CPABE.encrypt(mpk, st, policy)
   where chal represents the challenge query to be sent to the user 220, mpk represents the general public key, st represents a value randomly sampled by the bar 230, policy represents the policies generated by the trusted authorities 210, and CPABE.encrypt represents an encryption function according to a CP-ABE algorithm. After generating the challenge query (e.g., chal), the bar 230 may send chal to the user 220 to verify the age of the user 220. Additionally or alternatively, the bar 230 may include the value st with and/or as part of chal.

Based on receiving the challenge query, the user 220 may generate a response that validates their attributed in a repudiable manner. For example, using the user specific key associated with the attribute (e.g., sk) and the challenge query (e.g., chal), the user 220 may generate a response to send back to the bar 230 that validates their age. Stated mathematically, the user 220 may perform
resp=CPABE.decrypt(sk, chal)
   where resp represents the response generated by the user 220 to send to the bar 230, sk represents the user-specific secret key, chal represents the challenge query sent to the user 220, and CPABE.decrypt represents a decryption function according to a CP-ABE algorithm. After generating the response (e.g., resp), the user 220 may send the response to the bar 230 to verify the age of the user 220.

After receiving the response from the user 220, the bar 230 may verify that an expected correlation between the response and the randomly sampled value is observed. For example, the randomly sampled value and the response may be the same value, or have any other known and expected relationship. Based on the response and the randomly sampled value complying with the known relationship, the bar 230 may verify the age of the user 220. The exchange does not disclose other information regarding the user 220. While an example exchange is articulated with respect to the user 220 and the bar 230 using the credential from the DMV 214, it will be appreciated that a similar process may be followed for the user 220 to verify their bank information of the bank 216 with the rental store 232 in a similar or comparable manner.

In some embodiments, the third party 240 may attempt to obtain information about the user 220. For example, the third party 240 may offer to buy user information from the bar 230 and the rental store 232 to obtain marketing information or other user details regarding the user 220. However, because of the repudiable credential, the only information that the bar 230 obtains in the exchange is that the known relationship between the random value sampled by the bar 230 and the response of the user 220 exists. Such information does not provide any other personal information regarding the user 220. Furthermore, the third party 240 is unable to distinguish the information provided by the bar 230 and some other entity generating a random value to mimic or duplicate the information provided by the bar 230. Stated another way, the information provided by the bar 230 may be simulatable by anyone without privileged information. Additionally, as all that is disclosed is the existence of the known relationship with the random value, even if such information is accumulated across multiple vendors, such as the bar 230 and the rental store 232, the third party 240 is unable to correlate the data to the individual user 220 or to each other. In these and other embodiments, using the repudiable credential approach of the present disclosure, bad actors such as the third party 240 may be unable to obtain user information regarding the user 220 from the bar 230 and/or the rental store 232.

In addition or alternatively to the security provided to the user 220 regarding the exposure of their personal information, the bar 230 and/or the rental store 232 may be protected from others seeking to provide fake credentials. For example, the teen 250 may attempt to generate fake credentials to provide a response to the bar 230 to validate an older age so as to granted access to the bar 230. However, even with an incorrect credential (e.g., an sk related to an age younger than twenty one), or multiple instances of incorrect credentials, the teen 250 is unable to generate a correct credential. In these and other embodiments, when the teen 250 submits false credentials, the validation of the response (e.g., resp) from the teen may fail the validation of the known pre-existing relationship of the response with the value sampled at random by the bar 230. In these and other embodiments, the value of sk for the user 220 and/or the value of resp generated by the bar 230 and/or the rental store 232 may be indistinguishable from simulated values or versions of those terms as generated by the third party 240 and/or the teen 250.

Modifications, additions, or omissions may be made to the system 200 without departing from the scope of the disclosure. For example, the designations of different elements in the manner described is meant to help explain concepts described herein and is not limiting. Further, the system 200 may include any number of other elements or may be implemented within other systems or contexts than those described. For example, the system 200 may include any number of trusted authorities. As another example, there may be any number of nodes providing input to, and/or controlling the blockchain 212.

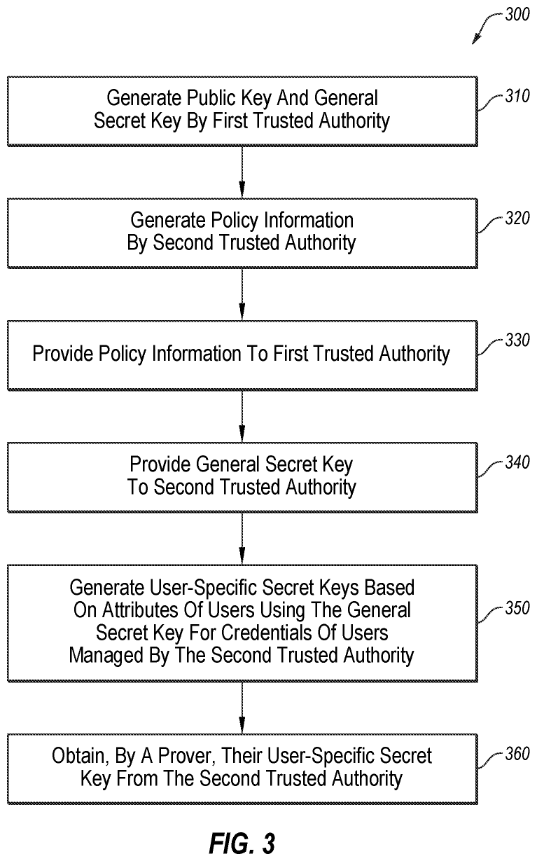

FIG. 3 illustrates an example flowchart of an example method 300 of performing preliminary operations to support the use of repudiable credentials, in accordance with one or more embodiments of the present disclosure. One or more operations of the method 300 may be performed by a system or device, or combinations thereof, such as the system 100, the trusted authority 110, the verifier 120 and/or the prover 130 of FIG. 1 and/or the system 200, the trusted authorities 210, the blockchain 212 (and/or associated systems/nodes), the bar 230, and/or the rental store 232 of FIG. 2. Although illustrated as discrete blocks, various blocks of the method 300 may be divided into additional blocks, combined into fewer blocks, or eliminated, depending on the desired implementation.

At block 310, a public key and a general secret key may be generated by a first trusted authority. For example, one or more master nodes or full nodes managing or operating the blockchain may generate the public key and the general secret key. As another example, a trusted authority that is responsible for a given credential (such as a DMV, a bank, etc.) may generate the public key and the general secret key. In these and other embodiments, such key generation may be performed according to a CP-ABE encryption algorithm. In some embodiments, such an operation may be expressed mathematically as Generate (mpk,msk)=CPABE.mskgen(λ).

At block 320, policy information may be generated by a second trusted authority. The policy information may include the form, format, etc. of attributes associated with a credential controlled and/or maintained by the second trusted authority. As another example, the policy may include information related to which attributes may be verified by the credential maintained by the second trusted authority (e.g., the policy generated by the DMV may indicate that a date of birth, home address, etc. may be verified by a driver's license). In some embodiments the second trusted authority may be the same entity as the first trusted authority. For example, the DMV may generate its own general secret key/public key while also generating the policy information.

At block 330, the policy information may be provided to the first trusted authority. For example, the second trusted authority may provide the policy information to the first trusted authority such that the policy information may be posted to the blockchain. By posting the policy information to the blockchain, the policy information may be verifiable and reliable. Additionally or alternatively, an entity seeking to obtain verification of an attribute may obtain the information used in such a verification directly from the blockchain without going to the second trusted authority to obtain the policy information.

At block 340, the general secret key may be provided to the second trusted authority. For example, the first trusted authority may establish a secure communication channel and provide the general secret key to the second trusted authority. In these and other embodiments, the general secret key may be kept secured and undisclosed to an entity seeking to verify an attribute as well as an entity seeking to have their attribute verified by a credential associated with that attribute. In some embodiments, the general secret key may be used across multiple trusted authorities (e.g., the bank and the DMV may utilize the same general secret key). Additionally or alternatively, the general secret key may be specific to a particular trusted authority (e.g., specific to the DMV such that different general secret keys are used by the DMV and the bank).

At block 350, using the general secret key, user-specific secret keys may be generated based on attributes of users. For example, for a credential with associated attributes managed and/or controlled by the second trusted authority, the second trusted authority may generate a set of user-specific secret keys (e.g., sk) using the general secret key and the attributes of the users. In some embodiments, the user-specific secret keys may be generated according to a CP-ABE encryption algorithm, such as sk=CPABE.keygen(msk, attributes).

At block 360, a prover may obtain their user-specific secret key from the second trusted authority. For example, a user may establish a secure communication channel with the second trusted authority over which the second trusted authority may provide the user-specific secret key generated at the block 350 for the user. In some embodiments, the user-specific secret key may be specific to a particular attribute rather than all information accessible via the credential controlled by the second trusted authority (e.g., the user-specific the secret key may be specific to the age of the user as indicated by their driver's license, and not tied to all information available on their driver's license).

Modifications, additions, or omissions may be made to the method 300 without departing from the scope of the disclosure. For example, the operations of the method 300 may be implemented in differing order. Additionally or alternatively, two or more operations may be performed at the same time. Furthermore, the outlined operations and actions are provided as examples, and some of the operations and actions may be optional, combined into fewer operations and actions, or expanded into additional operations and actions without detracting from the essence of the disclosed embodiments.

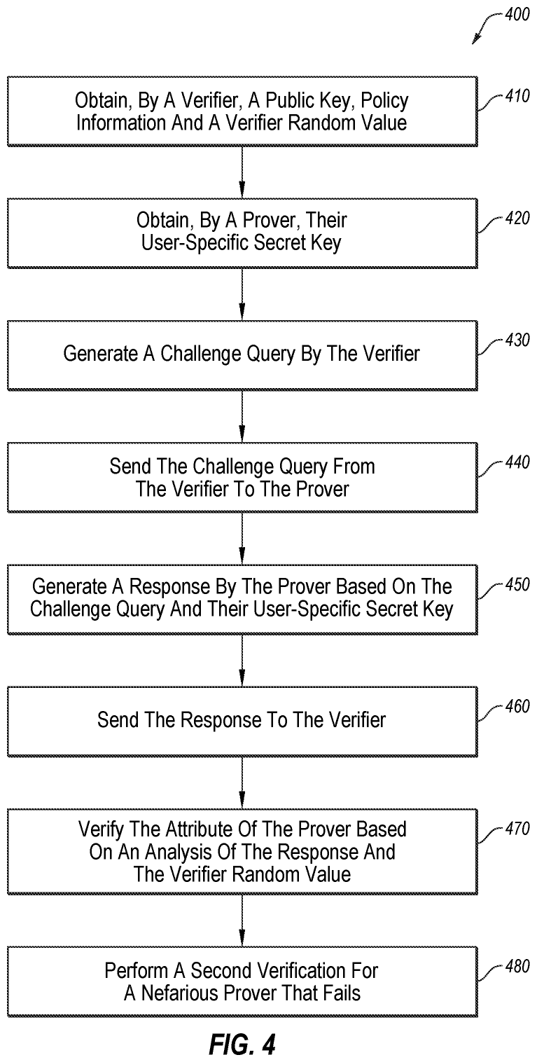

FIG. 4 illustrates an example flowchart of an example method 400 of the use of repudiable credentials, in accordance with one or more embodiments of the present disclosure. One or more operations of the method 400 may be performed by a system or device, or combinations thereof, such as the system 100, the trusted authority 110, the verifier 120 and/or the prover 130 of FIG. 1 and/or the system 200, the trusted authorities 210, the blockchain 212 (and/or associated systems/nodes), the bar 230, and/or the rental store 232 of FIG. 2. Although illustrated as discrete blocks, various blocks of the method 400 may be divided into additional blocks, combined into fewer blocks, or eliminated, depending on the desired implementation.

At block 410, a verifier may obtain a public key, policy information, and a verifier random value. For example, the verifier may obtain a general public key generated by a trusted authority and the policy information from the blockchain. By providing the information on the blockchain, the verifier may or may not be in actual contact with the entity in control of the credential via which the verifier is seeking to validate an attribute of a user. The verifier may randomly sample a value to derive the verifier random value.

At block 420, a prover may obtain their user-specific secret key. The block 420 may be similar or comparable to the block 360 of FIG. 3.

At block 430, a challenge query may be generated by the verifier. For example, the verifier may generate its own verifier random value by randomly sampling a number. The verifier random value may be unknown by other entities. Using the verifier random value, and the policy information and public key obtained at the block 410, the verifier may generate the challenge query. In some embodiments, the challenge query may be generated using a CP-ABE encryption algorithm. For example, the verifier may perform the operation:
chal=CPABE.encrypt(mpk, st, policy).

At block 440, the challenge query may be sent from the verifier to the prover. For example, the prover may arrive at a bar and seek to verify their age. In response, the bar may generate a query as an electronic message to send to an electronic device of the prover.

In some embodiments, the prover may request their user-specific secret key in response to receiving the challenge query sent at the block 440, such that the block 420 may be performed in response to the operation of block 440. For example, upon receiving the challenge query, the prover may initiate a secure communication channel to the entity controlling or otherwise responsible for their credential that includes the attribute to be verified, and may obtain the user-specific secret key corresponding to their attribute.

At block 450, the prover may generate a response based on the challenge query and their user-specific secret key. For example, the user may perform a CP-ABE decryption process on the challenge query using their user-specific secret key to derive a response. Such an operation may be represented by:
resp=CPABE.decrypt(sk, chal).

At block 460, the response may be sent to the verifier. For example, the electronic device of the prover may generate a message that includes the response that is sent to the electronic device of the verifier. In some embodiments, the response may include the verifier random value, or some value with a known relationship to the verifier random value.

At block 470, the attribute of the prover may be verified by the verifier based on an analysis of the response and the verifier random value. In some embodiments, the verification is based on the response being the same as the verifier random value. Additionally or alternatively, the verification may be based on the response having some known relationship with the verifier random value. By using the approach described in the present disclosure, the verifier may be able to verify the attribute of the prover, while the only information actually provided to the verifier is a random value.

At block 480, a second verification may be performed for a nefarious prover that fails. For example, the nefarious prover may be in possession of multiple attributes that fail the verification and/or a set of secret keys associated with attributes that would fail the verification. However, the nefarious prover may be unable to generate a response to the query that successfully validates an attribute. Additionally or alternatively, even repeated attempts to generate a successful query may be unsuccessful.

Modifications, additions, or omissions may be made to the method 400 without departing from the scope of the disclosure. For example, the operations of the method 400 may be implemented in differing order. Additionally or alternatively, two or more operations may be performed at the same time. Furthermore, the outlined operations and actions are provided as examples, and some of the operations and actions may be optional, combined into fewer operations and actions, or expanded into additional operations and actions without detracting from the essence of the disclosed embodiments. In some embodiments, any sending or receiving of information may be conveyed via any means, including packetized messages, information embedded in Quick Response (QR) codes or other images, etc.

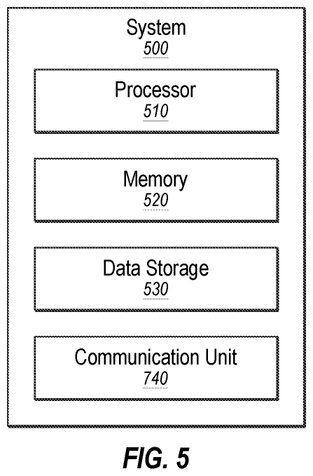

FIG. 5 illustrates an example computing system 500, according to at least one embodiment described in the present disclosure. The computing system 500 may include a processor 510, a memory 520, a data storage 530, and/or a communication unit 540, which all may be communicatively coupled. Any or all of the system 100 of FIG. 1 may be implemented as a computing system consistent with the computing system 500, including the trusted authority 110, the verifier 120 and/or the prover 130.

Generally, the processor 510 may include any suitable special-purpose or general-purpose computer, computing entity, or processing device including various computer hardware or software modules and may be configured to execute instructions stored on any applicable computer-readable storage media. For example, the processor 510 may include a microprocessor, a microcontroller, a digital signal processor (DSP), an application-specific integrated circuit (ASIC), a Field-Programmable Gate Array (FPGA), or any other digital or analog circuitry configured to interpret and/or to execute program instructions and/or to process data.

Although illustrated as a single processor in FIG. 5, it is understood that the processor 510 may include any number of processors distributed across any number of network or physical locations that are configured to perform individually or collectively any number of operations described in the present disclosure. In some embodiments, the processor 510 may interpret and/or execute program instructions and/or process data stored in the memory 520, the data storage 530, or the memory 520 and the data storage 530. In some embodiments, the processor 510 may fetch program instructions from the data storage 530 and load the program instructions into the memory 520.

After the program instructions are loaded into the memory 520, the processor 510 may execute the program instructions, such as instructions to perform any of the methods 300 and/or 400 of FIGS. 3 and 4, respectively. For example, the processor 810 may obtain instructions regarding encrypting attributes of users, posting information to the blockchain, and/or otherwise facilitating the exchange of repudiable credentials.

The memory 520 and the data storage 530 may include computer-readable storage media or one or more computer-readable storage mediums for carrying or having computer-executable instructions or data structures stored thereon. Such computer-readable storage media may be any available media that may be accessed by a general-purpose or special-purpose computer, such as the processor 510. For example, the memory 520 and/or the data storage 530 may store a complete copy of a blockchain (such as the blockchain 222 of FIG. 2). In some embodiments, the computing system 500 may or may not include either of the memory 520 and the data storage 530.

By way of example, and not limitation, such computer-readable storage media may include non-transitory computer-readable storage media including Random Access Memory (RAM), Read-Only Memory (ROM), Electrically Erasable Programmable Read-Only Memory (EEPROM), Compact Disc Read-Only Memory (CD-ROM) or other optical disk storage, magnetic disk storage or other magnetic storage devices, flash memory devices (e.g., solid state memory devices), or any other storage medium which may be used to carry or store desired program code in the form of computer-executable instructions or data structures and which may be accessed by a general-purpose or special-purpose computer. Combinations of the above may also be included within the scope of computer-readable storage media. Computer-executable instructions may include, for example, instructions and data configured to cause the processor 510 to perform a certain operation or group of operations.

The communication unit 540 may include any component, device, system, or combination thereof that is configured to transmit or receive information over a network. In some embodiments, the communication unit 540 may communicate with other devices at other locations, the same location, or even other components within the same system. For example, the communication unit 540 may include a modem, a network card (wireless or wired), an optical communication device, an infrared communication device, a wireless communication device (such as an antenna), and/or chipset (such as a Bluetooth device, an 802.6 device (e.g., Metropolitan Area Network (MAN)), a WiFi device, a WiMax device, cellular communication facilities, or others), and/or the like. The communication unit 540 may permit data to be exchanged with a network and/or any other devices or systems described in the present disclosure. For example, the communication unit 540 may allow the system 500 to communicate with other systems, such as computing devices and/or other networks.

One skill in the art, after reviewing this disclosure, may recognize that modifications, additions, or omissions may be made to the system 500 without departing from the scope of the present disclosure. For example, the system 500 may include more or fewer components than those explicitly illustrated and described.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, it may be recognized that changes may be made in form and detail without departing from the scope of the present disclosure. Thus, the present disclosure is limited only by the claims.

In some embodiments, the different components, modules, engines, and services described herein may be implemented as objects or processes that execute on a computing system (e.g., as separate threads). While some of the systems and processes described herein are generally described as being implemented in software (stored on and/or executed by general purpose hardware), specific hardware implementations or a combination of software and specific hardware implementations are also possible and contemplated.

Terms used herein and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc. For example, the use of the term “and/or” is intended to be construed in this manner.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

Additionally, the use of the terms “first,” “second,” “third,” etc. are not necessarily used herein to connote a specific order. Generally, the terms “first,” “second,” “third,” etc., are used to distinguish between different elements. Absence a showing of a specific that the terms “first,” “second,” “third,” etc. connote a specific order, these terms should not be understood to connote a specific order.

All examples and conditional language recited herein are intended for pedagogical objects to aid the reader in understanding the invention and the concepts contributed by the inventor to furthering the art, and are to be construed as being without limitation to such specifically recited examples and conditions. Although embodiments of the present disclosure have been described in detail, it should be understood that various changes, substitutions, and alterations could be made hereto without departing from the spirit and scope of the present disclosure.

The previous description of the disclosed embodiments is provided to enable any person skilled in the art to make or use the present disclosure. Various modifications to these embodiments will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

What is claimed is:

1. A method comprising:
obtaining policy information and a public key from a first trusted authority regarding an attribute of users to be verified;
generating a challenge query based on the public key, the policy information, and a verifier random value;
sending the challenge query to a user to verify the attribute of the user;
receiving a response from the user that is responsive to the challenge query, the response based on the challenge query and a user-specific secret key obtained by the user from a second trusted authority, the user-specific secret key generated by the second trusted authority based on a general secret key corresponding to the public key and the attribute of the user; and
verifying the attribute of the user based on the response.

2. The method of claim 1, wherein the policy information and the public key are published on a blockchain.

3. The method of claim 2, wherein the first trusted authority is a distributed authority that validates postings to the blockchain.

4. The method of claim 1, wherein the public key and the general secret key are generated using a Ciphertext-Policy Attribute-Based Encryption (CP-ABE) master secret key generation algorithm.

5. The method of claim 1, wherein generating the challenge query comprises generating the challenge query using a CP-ABE encryption scheme using the public key, the policy information, and the verifier random value as inputs.

6. The method of claim 5, wherein the response is generated by the user as a CP-ABE decryption operation performed on the challenge query using the user-specific secret key.

7. The method of claim 1, wherein the verification validates the attribute of the user without other information of the user being discoverable.

8. The method of claim 1, wherein the challenge query and the response are indistinguishable from simulated challenge queries and simulated responses generated without the user-specific secret key.

9. The method of claim 1, further comprising performing a second verification that fails, the second verification based on a second response that is generated based on repeated attempts to satisfy the challenge query, and further generated based on knowledge of a set of false user-specific secret keys that do not satisfy a policy associated with the policy information.

10. The method of claim 1, wherein the first trusted authority and the second trusted authority are the same entity.

11. One or more non-transitory computer-readable media containing instructions that, when executed by one or more processors, are configured to cause a system to perform operations, the operations comprising:
obtaining policy information and a public key from a first trusted authority regarding an attribute of users to be verified;
generating a challenge query based on the public key, the policy information, and a verifier random value;
sending the challenge query to a user to verify the attribute of the user;
receiving a response from the user that is responsive to the challenge query, the response based on the challenge query and a user-specific secret key obtained by the user from a second trusted authority, the user-specific secret key generated by the second trusted authority based on a general secret key corresponding to the public key and the attribute of the user; and
verifying the attribute of the user based on the response.

12. The computer-readable media of claim 10, wherein the policy information and the public key are published on a blockchain.

13. The computer-readable media of claim 12, wherein the first trusted authority is a distributed authority that validates postings to the blockchain.

14. The computer-readable media of claim 10, wherein the public key and the general secret key are generated using a Ciphertext-Policy Attribute-Based Encryption (CP-ABE) master secret key generation algorithm.

15. The computer-readable media of claim 10, wherein generating the challenge query comprises generating the challenge query using a CP-ABE encryption scheme using the public key, the policy information, and the verifier random value as inputs.

16. The computer-readable media of claim 15, wherein the response is generated by the user as a CP-ABE decryption operation performed on the challenge query using the user-specific secret key.

17. The computer-readable media of claim 10, wherein the verification validates the attribute of the user without other information of the user being discoverable.

18. The computer-readable media of claim 10, wherein the challenge query and the response are indistinguishable from simulated challenge queries and simulated responses generated without the user-specific secret key.

19. The computer-readable media of claim 10, wherein the operations further comprise performing a second verification that fails, the second verification based on a second response that is generated based on repeated attempts to satisfy the challenge query, and further generated based on knowledge of a set of false user-specific secret keys that do not satisfy a policy associated with the policy information.

20. The computer-readable media of claim 10, wherein the first trusted authority and the second trusted authority are the same entity.
